(19) United States
(12) Patent Application Publication
(10) Pub. No.: US 2024/0031954 A1
(43) Pub. Date: Jan. 25, 2024

(54) SYNCHRONIZED LONG RANGE SIDELINK COMMUNICATION

(71) Applicant: QUALCOMM Incorporated, San Diego, CA (US)

(72) Inventors: Shuanshuan WU, San Diego, CA (US); Shailesh PATIL, San Diego, CA (US); Kapil GULATI, Belle Mead, NJ (US)

(21) Appl. No.: 17/813,502

(22) Filed: Jul. 19, 2022

(51) Int. Cl. H04W 56/00

(52) U.S. Cl. CPC H04W 56/001; H04W 56/004; H04W 92/18

(57) ABSTRACT

Various aspects of the present disclosure generally relate to wireless communication. In some aspects, a first user equipment (UE) may synchronize a transmission timing with the second UE via a communication link with the second UE. The UE may transmit a sidelink transmission on the communication link with an offset before or after the sidelink transmission and in accordance with the transmission timing, wherein a duration of the offset is based at least in part on a propagation delay between the first UE and the second UE, a maximum supported communication range of the first UE, or a range associated with the communication link. Numerous other aspects are provided.

### FIELD OF THE DISCLOSURE

Aspects of the present disclosure generally relate to wireless communication and specifically, to techniques and apparatuses for synchronized long range sidelink communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

UEs may communicate directly with one another via a communication link between the UEs referred to as a sidelink. Sidelink communications between UEs are subject to some amount of propagation delay. The propagation delay is the time duration taken for a signal, transmitted by a transmitting UE, to reach a receiving UE. The propagation delay may be approximately proportionate to the distance between the transmitting UE and the receiving UE. As this distance increases, the propagation delay increases proportionately. If the distance is larger than a threshold, then the propagation delay may exceed the length of a cyclic prefix of a sidelink transmission, which may lead to an inability to mitigate interference such as inter-symbol interference.

### SUMMARY

Some aspects described herein relate to a method of wireless communication performed by a first user equipment (UE). The method may include synchronizing a transmission timing with a second UE via a communication link with the second UE. The method may include transmitting a sidelink transmission on the communication link with an offset before or after the sidelink transmission and in accordance with the transmission timing, wherein a duration of the offset is based at least in part on a propagation delay between the first UE and the second UE, a maximum supported communication range of the first UE, or a range associated with the communication link.

Some aspects described herein relate to a method of wireless communication performed by a first user equipment (UE). The method may include synchronizing a reception timing with a second UE via a communication link with the second UE. The method may include receiving a sidelink transmission on the communication link with an offset before or after the sidelink transmission and in accordance with the reception timing, wherein a duration of the offset is based at least in part on a propagation delay between the first UE and the second UE, a maximum supported communication range of the second UE, or a range associated with the communication link.

Some aspects described herein relate to a non-transitory computer-readable medium that stores a set of instructions for wireless communication by a first user equipment (UE). The set of instructions, when executed by one or more processors of the first UE, may cause the first UE to synchronize a transmission timing with a second UE via a communication link with the second UE. The set of instructions, when executed by one or more processors of the first UE, may cause the first UE to transmit a sidelink transmission on the communication link with an offset before or after the sidelink transmission and in accordance with the transmission timing, wherein a duration of the offset is based at least in part on a propagation delay between the first UE and the second UE, a maximum supported communication range of the first UE, or a range associated with the communication link.

Some aspects described herein relate to a non-transitory computer-readable medium that stores a set of instructions for wireless communication by an UE. The set of instructions, when executed by one or more processors of the UE, may cause the UE to synchronize a reception timing with a second UE via a communication link with the second UE. The set of instructions, when executed by one or more processors of the first UE, may cause the first UE to receive a sidelink transmission on the communication link with an offset before or after the sidelink transmission and in accordance with the reception timing, wherein a duration of the offset is based at least in part on a propagation delay between the first UE and the second UE, a maximum supported communication range of the second UE, or a range associated with the communication link.

Some aspects described herein relate to an apparatus for wireless communication. The apparatus may include means for synchronizing a transmission timing with a second user equipment (UE) via a communication link with the second UE. The apparatus may include means for transmitting a sidelink transmission on the communication link with an offset before or after the sidelink transmission and in accordance with the transmission timing, wherein a duration of the offset is based at least in part on a propagation delay between the first UE and the second UE, a maximum supported communication range of the first UE, or a range associated with the communication link.

Some aspects described herein relate to an apparatus for wireless communication. The apparatus may include means for synchronizing a reception timing with a second user equipment (UE) via a communication link with the second UE. The apparatus may include means for receiving a sidelink transmission on the communication link with an offset before or after the sidelink transmission and in accordance with the reception timing, wherein a duration of the offset is based at least in part on a propagation delay between the apparatus and the second UE, a maximum supported communication range of the second UE, or a range associated with the communication link.

Some aspects described herein relate to a first user equipment (UE) for wireless communication. The first user equipment may include at least one processor and at least one memory, communicatively coupled with the at least one processor, that stores processor-readable code. The processor-readable code, when executed by the at least one processor, may be configured to cause the first user equipment to synchronize a transmission timing with a second UE via a communication link with the second UE. The processor-readable code, when executed by the at least one processor, may be configured to cause the first user equipment to transmit a sidelink transmission on the communication link with an offset before or after the sidelink transmission and in accordance with the transmission timing, wherein a duration of the offset is based at least in part on a propagation delay between the first UE and the second UE, a maximum supported communication range of the first UE, or a range associated with the communication link.

Some aspects described herein relate to a first UE for wireless communication. The first UE may include at least one processor and at least one memory, communicatively coupled with the at least one processor, that stores processor-readable code. The processor-readable code, when executed by the at least one processor, may be configured to cause the first UE to synchronize a reception timing with a second UE via a communication link with the second UE. The processor-readable code, when executed by the at least one processor, may be configured to cause the first UE to receive a sidelink transmission on the communication link with an offset before or after the sidelink transmission and in accordance with the reception timing, wherein a duration of the offset is based at least in part on a propagation delay between the first UE and the second UE, a maximum supported communication range of the second UE, or a range associated with the communication link.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example of sidelink communications, in accordance with the present disclosure.

FIG. 4 is a diagram illustrating an example of sidelink communications and access link communications in accordance with the present disclosure.

FIG. 5 is a diagram illustrating an example of synchronization based on a time value at a transmitting UE in accordance with the present disclosure.

FIG. 6 is a diagram illustrating an example of synchronization based on a time value at a receiving UE in accordance with the present disclosure.

FIG. 7 is a diagram illustrating an example of synchronization based on a time value at a selected UE in accordance with the present disclosure.

FIG. 8 is a flowchart illustrating an example process performed, for example, by a first UE that supports synchronized long range sidelink communication in accordance with the present disclosure.

FIG. 9 is a flowchart illustrating an example process performed, for example, by a first UE that supports synchronized long range sidelink communication in accordance with the present disclosure.

FIG. 10 is a diagram of an example apparatus for wireless communication that supports synchronized long range sidelink communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to time synchronization between UEs communicating with one another at a range that satisfies or exceeds a threshold, and to implementation of an offset associated with communications between such UEs. Some aspects more specifically relate to synchronizing at a selected UE, such as a transmitting UE, a receiving UE, or a head UE. In some examples, the synchronization is a transmitting-UE-centric synchronization, in which the transmitting UE's timing is aligned with a time value at the transmitting UE and the receiving UE's timing is adjusted (for example, based on a propagation delay between the UEs) in accordance with an offset. In some other examples, the synchronization is a receiving-UE-centric synchronization, in which the receiving UE's timing is aligned with a time value at the receiving UE and the transmitting UE's timing is adjusted (for example, based on propagation delay between the UEs) in accordance with an offset. In some aspects, the offset (which may be referred to as a gap) is based on the propagation delay between the UEs, and is configured such that interference due to the propagation delay is mitigated or eliminated. The offset can occur before a sidelink transmission or after a sidelink transmission, and may be implemented at the transmitting UE or at the receiving UE.

Particular aspects of the subject matter described in this disclosure can be implemented to realize one or more of the following potential advantages. In some examples, the described techniques can be used to enable communication at ranges over which the propagation delay approaches or exceeds the cyclic prefix length. In some examples, the described techniques can be used to enable communication between a UE and different UEs at different ranges relative to the UE. In some examples, the described techniques can be used to reduce interference due to propagation delay, such as inter-link interference or inter-symbol interference.

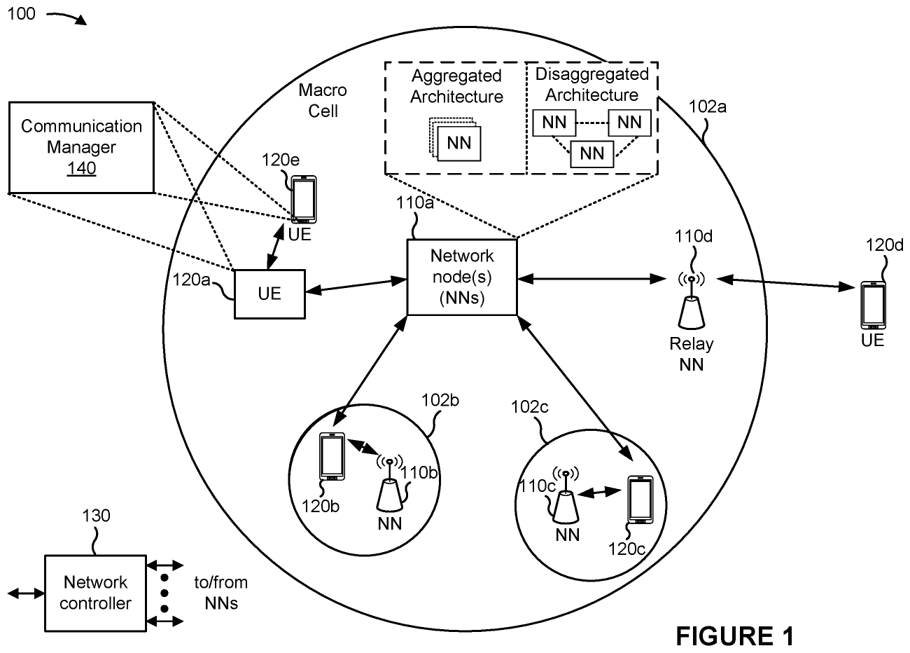

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (Dus), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more Cus, or one or more Dus. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a first UE (e.g., the UE 120) may include a communication manager 140. As described in more detail elsewhere herein, the communication manager 140 may synchronize a transmission timing with a second UE via a communication link with the second UE; and transmit a sidelink transmission on the communication link with an offset before or after the sidelink transmission and in accordance with the transmission timing based at least in part on the range satisfying the threshold. Additionally, or alternatively, the communication manager 140 may perform one or more other operations described herein.

In some aspects, the communication manager 140 may synchronize a reception timing with a second UE via a communication link with the second UE based at least in part on a range of the first UE and the second UE satisfying a threshold; and receive a sidelink transmission on the communication link with an offset before or after the sidelink transmission and in accordance with the reception timing based at least in part on the range satisfying the threshold. Additionally, or alternatively, the communication manager 140 may perform one or more other operations described herein.

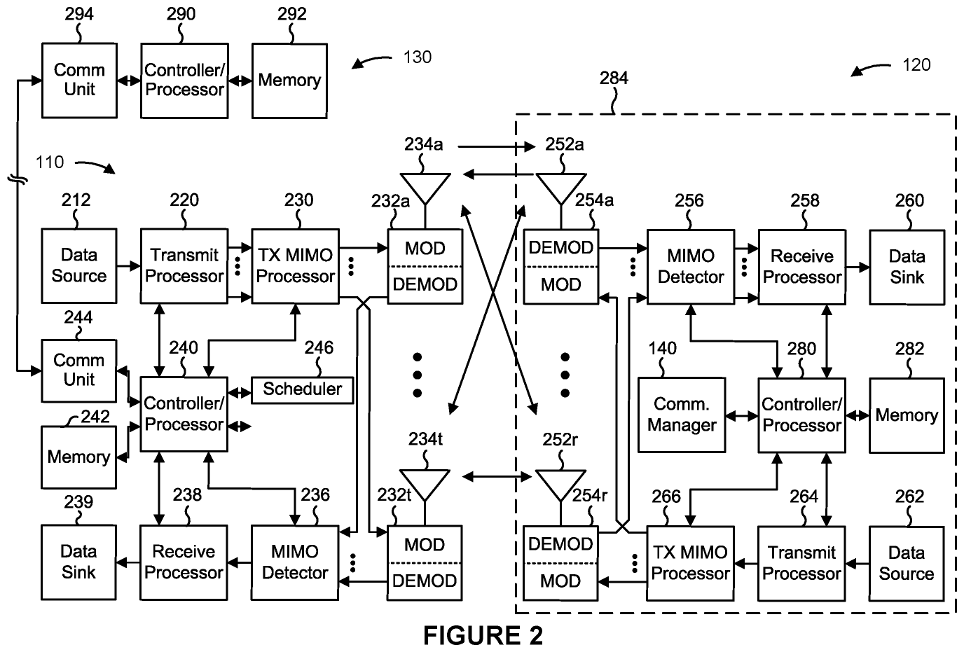

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more Cus, or one or more Dus.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

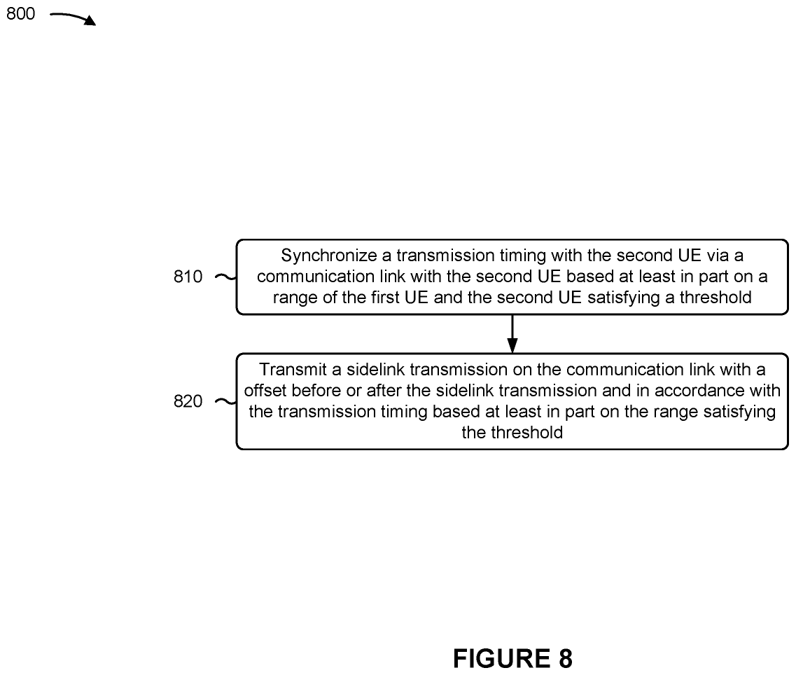

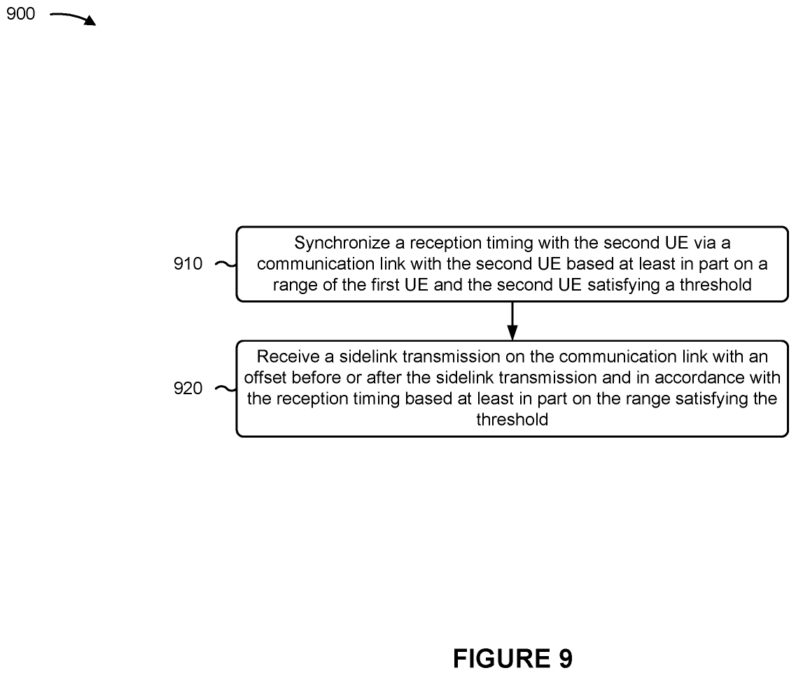

The controller/processor 240 of the network node 110, the controller/processor 280 of the UE 120, or any other component(s) of FIG. 2 may perform one or more techniques associated with sidelink synchronization, as described in more detail elsewhere herein. For example, the controller/processor 240 of the network node 110, the controller/processor 280 of the UE 120, or any other component(s) of FIG. 2 may perform or direct operations of, for example, process 800 of FIG. 8, process 900 of FIG. 9, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8, process 900 of FIG. 9, or other processes as described herein. In some examples, executing instructions may include running the instructions, converting the instructions, compiling the instructions, or interpreting the instructions, among other examples.

In some aspects, a first UE (e.g., the UE 120) includes means for synchronizing a transmission timing with a second UE via a communication link with the second UE; and means for transmitting a sidelink transmission on the communication link with an offset before or after the sidelink transmission and in accordance with the transmission timing based at least in part on the range satisfying the threshold. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first UE (e.g., the UE 120) includes means for synchronizing a reception timing with a second UE via a communication link with the second UE; and means for receiving a sidelink transmission on the communication link with an offset before or after the sidelink transmission and in accordance with the reception timing based at least in part on the range satisfying the threshold. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more Cus, one or more Dus, one or more RUs, or a combination thereof).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more Cus, one or more Dus, or one or more RUs). In some examples, a CU may be implemented within a network node, and one or more Dus may be co-located with the CU, or alternatively, may be geographically or virtually distributed throughout one or multiple other network nodes. The Dus may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

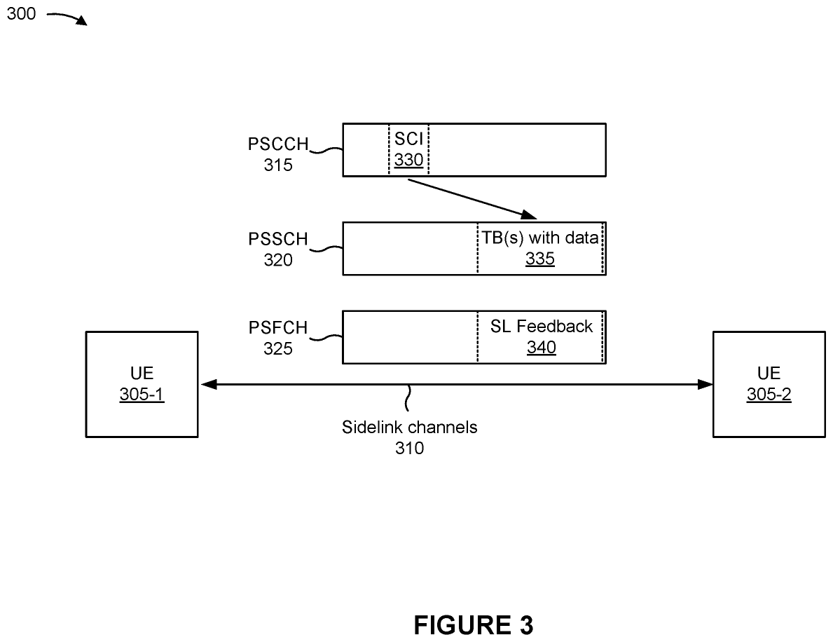

FIG. 3 is a diagram illustrating an example 300 of sidelink communications, in accordance with the present disclosure.

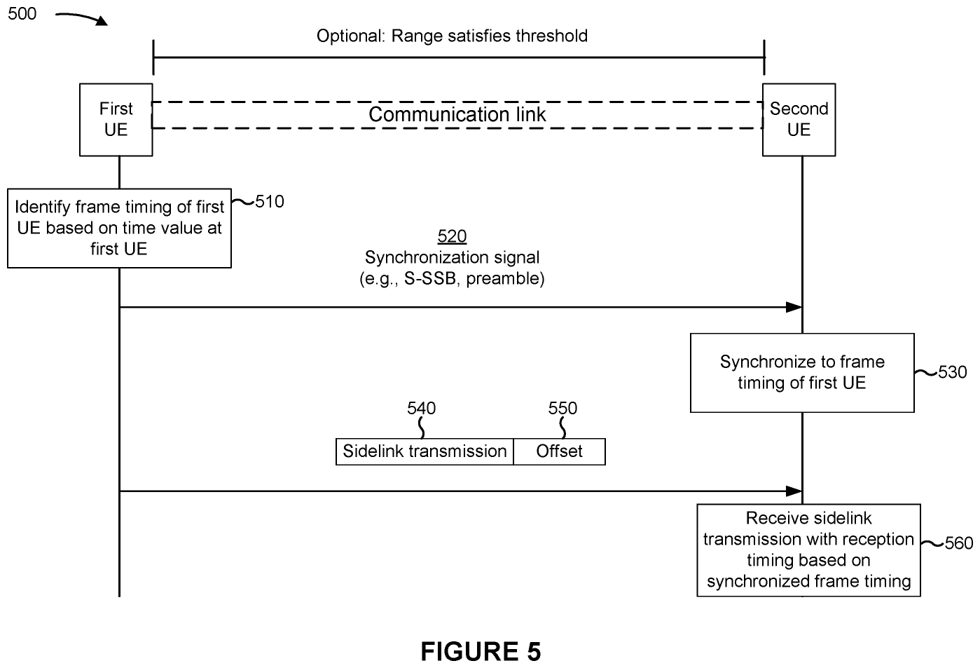

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (which may include V2V communications, V2I communications, or V2P communications) or mesh networking. In some aspects, the UEs 305 (UE 305-1 and UE 305-2) may correspond to one or more other UEs described elsewhere herein, such as UE 120. In some aspects, the one or more sidelink channels 310 may use a sidelink interface such as a PC5 interface or may operate in a high frequency band (such as the 5.9 GHz band, among other examples). Additionally or alternatively, the UEs 305 may synchronize timing of transmission time intervals (TTIs) (such as frames, subframes, slots, or symbols) using global navigation satellite system (GNSS) timing. The UEs 305 may synchronize, for example, using techniques described with regard to FIGS. 5, 6, and 7.

As further shown in FIG. 3, the one or more sidelink channels 310 may include a physical sidelink control channel (PSCCH) 315, a physical sidelink shared channel (PSSCH) 320, and a physical sidelink feedback channel (PSFCH) 325. The PSCCH 315 may be used to communicate control information, similar to a physical downlink control channel (PDCCH) or a physical uplink control channel (PUCCH) used for cellular communications with a network node 110 via an access link or an access channel. The PSSCH 320 may be used to communicate data, similar to a physical downlink shared channel (PDSCH) or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (such as time resources, frequency resources, or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (including acknowledgement or negative acknowledgement (ACK/NACK) information), transmit power control (TPC), or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (such as time resources, frequency resources, or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a betan offset for the SCI-2, a quantity of PSSCH DMRS ports, or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, or a channel state information (CSI) report trigger.

In some aspects, the one or more sidelink channels 310 may use resource pools. A resource pool is a configured set of sidelink resources for sidelink communication. For example, a scheduling assignment (for example, included in SCI 330) may be transmitted in sub-channels using specific resource blocks (RBs) across time. In some aspects, data transmissions (on the PSSCH 320) associated with a scheduling assignment may occupy adjacent RBs in the same subframe as the scheduling assignment (such as using frequency division multiplexing). In some aspects, a scheduling assignment and associated data transmissions are not transmitted on adjacent RBs.

In some aspects, a UE 305 may operate using a sidelink transmission mode (referred to as Mode 1) where resource selection and scheduling is performed by a network node 110 (such as a base station, a CU, or a DU). For example, the UE 305 may receive a grant (such as in downlink control information (DCI) or in a radio resource control (RRC) message, such as for configured grants) from the network node 110 (directly or via one or more other network nodes) for sidelink channel access or scheduling. In some aspects, a UE 305 may operate using a transmission mode (referred to as Mode 2) where resource selection and scheduling is performed by the UE 305 (such as rather than a network node 110). In some aspects, the UE 305 may perform resource selection and scheduling by sensing channel availability for transmissions. For example, the UE 305 may measure a received signal strength indicator (RSSI) parameter (such as a sidelink-RSSI (S-RSSI) parameter) associated with various sidelink channels, may measure a reference signal received power (RSRP) parameter (such as a PSSCH-RSRP parameter) associated with various sidelink channels, or may measure a reference signal received quality (RSRQ) parameter (such as a PSSCH-RSRQ parameter) associated with various sidelink channels. The UE 305 may select a channel for transmission of a sidelink communication based at least in part on the measurement(s).

Additionally or alternatively, the UE 305 may perform resource selection or scheduling using SCI 330 received in the PSCCH 315, which may indicate occupied resources and channel parameters. Additionally or alternatively, the UE 305 may perform resource selection and scheduling by determining a channel busy ratio (CBR) associated with various sidelink channels, which may be used for rate control (such as by indicating a maximum number of resource blocks that the UE 305 can use for a particular set of subframes).

In the transmission mode where resource selection and scheduling is performed by a UE 305, the UE 305 may generate sidelink grants, and may transmit the grants in SCI 330. A sidelink grant may indicate, for example, one or more parameters (which may be referred to as transmission parameters) to be used for an upcoming sidelink transmission, such as one or more resource blocks to be used for the upcoming sidelink transmission on the PSSCH 320 (for TB s 335), one or more subframes to be used for the upcoming sidelink transmission, or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally or alternatively, the UE 305 may generate a sidelink grant for event-driven scheduling, such as for an on-demand sidelink message.

Sidelink communication can occur in a distributed and synchronized manner. For example, sidelink communication may be considered distributed because different cast types of transmissions (such as unicast, groupcast, and broadcast) can share the same resource pool. A sidelink UE can communicate with multiple UEs simultaneously, using the same or different cast types. In some deployments, UEs communicating over the sidelink may be globally synchronized, such as using a GNSS timing value as a reference for transmitting and receiving UEs, or by sharing the same timing locally (for example, transmission timing and reception timing may be based on a sidelink synchronization signal transmission, such as a sidelink synchronization signal (SLSS) or sidelink synchronization signal block (S-SSB) transmission. In some deployments, sidelink synchronization and communication are decoupled. For example, a first UE may be synchronized with a synchronization source A (such as a GNSS time value, a time value associated with a gNB, or a time value associated with another UE) while communicating with a second UE. As a result, unlike access link communications, sidelink transmission timing and reception timing are not perfectly aligned, due to this decoupling and propagation delay between the first UE and the second UE. Generally, UEs can still communicate over the sidelink by using a cyclic prefix (CP) of an OFDM signal, which absorbs the potential timing difference between transmission and reception. However, the handling of timing misalignment using a cyclic prefix is based on the assumption that the timing difference is limited (such as shorter than, or not significantly longer than, a CP duration), which may only be applicable in situations where the UE-to-UE communication range is limited.

As mentioned, in some deployments, UEs perform sidelink synchronization based on sidelink synchronization signals. For example, multiple UEs may transmit the same signal (such as the same S-SSB) in the same time and frequency resource, which is referred to as single frequency network (SFN) type S-SSB transmission. When a UE's timing is synchronized to a synchronization source (such as a UE transmitting a synchronization signal), the UE may transmit a sidelink synchronization signal (such as an S-SSB) to propagate the timing. For example, UEs directly synchronized to a GNSS time value may transmit S-SSBs in a dedicated S-SSB resource. A UE synchronized based on a detected S-SSB transmission may transmit an S-SSB in another S-SSB resource. This S-SSB transmission based synchronization scheme can augment sidelink synchronization signal strength and can facilitate wide-area synchronization.

In some deployments, sidelink synchronization is based on a hierarchical protocol. A UE can be synchronized to different synchronization sources, which may have different priorities. For example, in GNSS based sidelink synchronization, synchronization to a GNSS time value may have a highest priority, a UE directly synchronizing to a GNSS time value (based on an S-SSB transmitted by a UE synchronized to a GNSS time value) may have a second highest priority, a UE indirectly synchronizing to a GNSS time value (based on an S-SSB transmitted by a UE synchronized to an S-SSB transmitted by a UE synchronized to a GNSS time value) may have a third highest priority, and all other UEs may have a lowest priority (for example, other UEs may use a self-determined timing by synchronization with a reference UE when there is no GNSS time value, and no S-SSB signal is detected). As used herein, “synchronizing” may include determining a frame number (such as a direct frame number (DFN)) and a time associated with a slot boundary. In some examples, a UE may synchronize a transmission timing or a reception timing, as described elsewhere herein.

Long range sidelink communication may facilitate use cases such as beyond visual line of sight (BVLOS) unmanned aerial vehicle (UAV) operation. For example, long range sidelink communication may occur over a range of up to (or beyond) approximately 100 miles. Long range sidelink communication may generally have a free-space type signal propagation (as compared to signal propagation in the presence of blockers or other obstructions) and may have a large transmit power (such as up to 50 watts). However, propagation delay increases linearly with the distance over which a transmission propagates. For example, a transmission with a 100-mile range may experience approximately 0.53 ms of propagation delay, which is longer than a slot at a kHz subcarrier spacing.

Synchronization using SFN-type S-SSB transmission may be infeasible for long range sidelink communication. For example, in a traditional (not long range) sidelink deployment, GNSS timing is the reference for synchronization, which is applicable at both a transmitting UE and a receiving UE, due to the short communication range of the transmitting UE and the receiving UE. Thus, the GNSS timing may be considered a system-wide reference point for synchronization, and UEs may synchronize to the GNSS timing directly or indirectly (as described above). However, for long range sidelink communication, the increased propagation delay, relative to shorter range sidelink communication, may mean that the transmitting UE and the receiving UE cannot both synchronize to GNSS timing. Thus, a system-wide synchronization of frame timing may be infeasible when a range between a transmitting UE and a receiving UE satisfies a threshold. For example, consider a receiving UE that is communicating with two transmitting UEs: a first UE that is 5 miles away from the receiving UE, and a second UE that is 80 miles away from the receiving UE. In this example, enforcing a system-wide timing based on the GNSS value will lead to inaccurate synchronization (due to propagation delay) for at least one of these UEs. Furthermore, the increased propagation delay of long range sidelink communications may introduce challenges for physical layer channel structure and resource mapping.

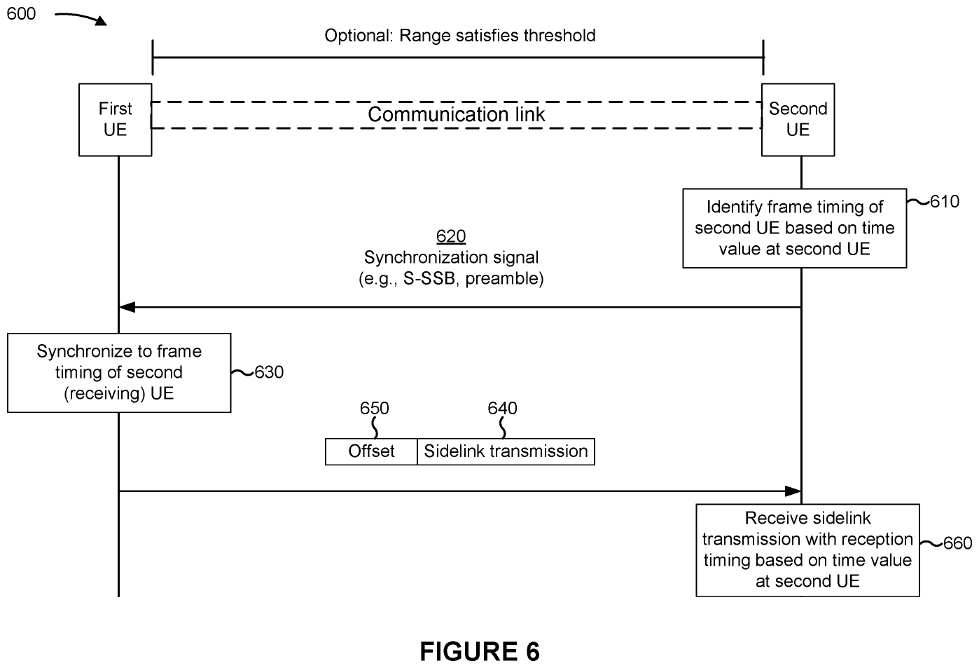

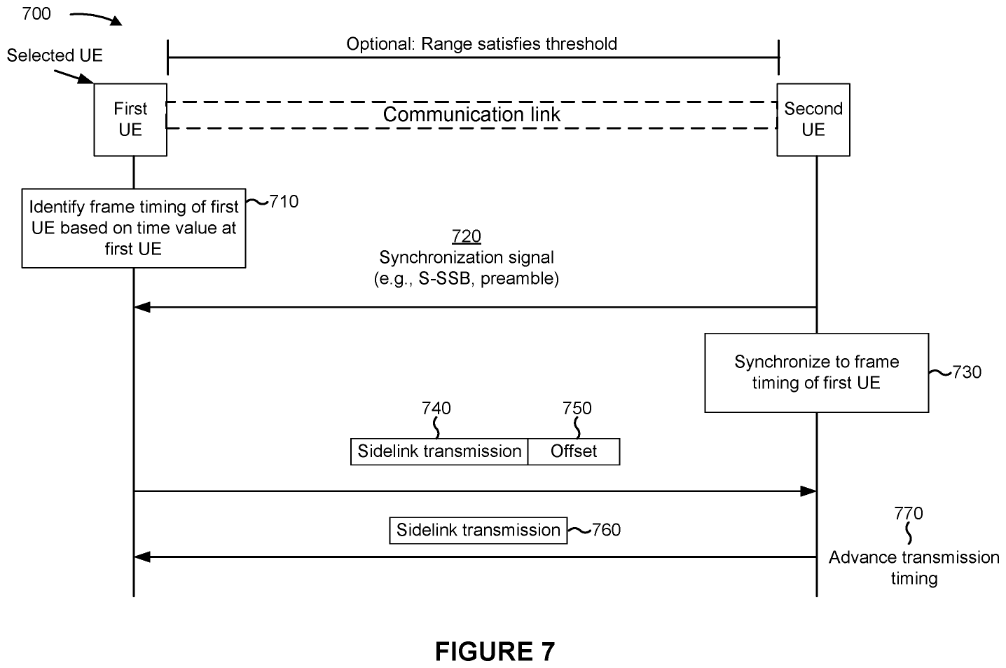

Some techniques described herein provide synchronization, between a first UE and a second UE, to a time value at a selected UE of the first UE and the second UE. In some examples, described with regard to FIG. 5, the selected UE is a transmitting UE of the first UE and the second UE, and the synchronization is per transmission direction. In some other examples, described with regard to FIG. 6, the selected UE is a receiving UE of the first UE and the second UE, and the synchronization is per transmission direction. In yet other examples, described with regard to FIG. 7, the synchronization is per communication link, such that the selected UE may not change irrespective of whether the selected UE is a transmitting UE or a receiving UE. Furthermore, an offset (sometimes referred to as a gap) is provided either before a sidelink transmission or after the sidelink transmission, such that inter-link or inter-slot interference is avoided. In this way, synchronization is between UEs communicating with one another over the sidelink (rather than system-wide irrespective of which UEs are communicating with one another). Thus, synchronization of long distance sidelink communication is improved, which increases throughput, reduces interference, and increases the range over which sidelink UEs can communicate with one another.

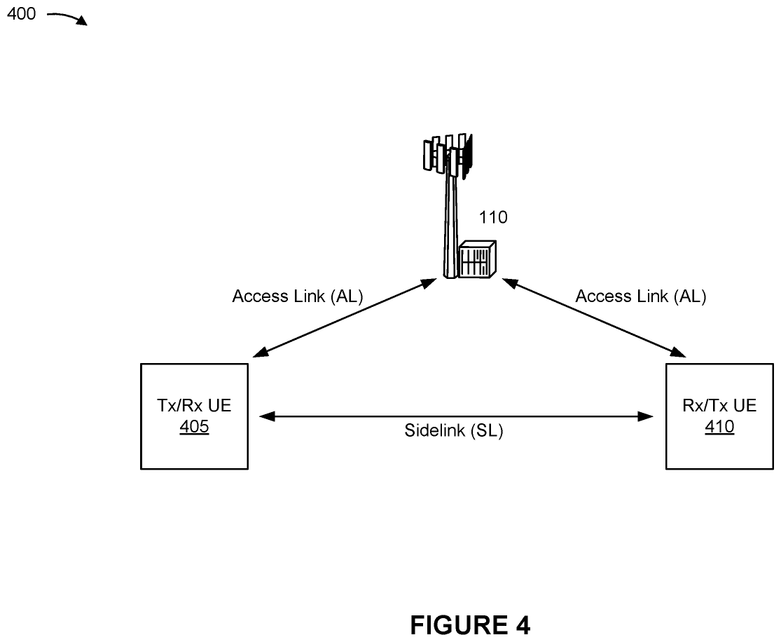

FIG. 4 is a diagram illustrating an example 400 of sidelink communications and access link communications in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (directly or via one or more other network nodes), such as via a first access link. Additionally or alternatively, in some sidelink modes, the network node 110 may communicate with the Rx/Tx UE 410 (directly or via one or more other network nodes), such as via a first access link. The Tx/Rx UE 405 or the Rx/Tx UE 410 may correspond to one or more UEs described elsewhere herein, such as the UE 120 of FIG. 1. Thus, a direct link between UEs 120 (such as via a PC5 interface) may be referred to as a sidelink or a communication link, and a direct link between a network node 110 and a UE 120 (for example, via a Uu interface) may be referred to as an access link. Sidelink communications may be transmitted via the communication link, and access link communications may be transmitted via the access link. An access link communication may be either a downlink communication (from a network node 110 to a UE 120) or an uplink communication (from a UE 120 to a network node 110).

FIG. 5 is a diagram illustrating an example 500 of synchronization based on a time value at a transmitting UE in accordance with the present disclosure. FIG. 5 includes a first UE (such as UE 120, UE 305, UE 405, or UE 410), which is a transmitting UE, and a second UE (such as UE 120, UE 305, UE 405, or UE 410), which is a receiving UE. In the example of FIG. 5, the first UE and the second UE synchronize according to a time value at the first UE. FIG. 5 is an example of transmitter-centric and per-direction synchronization. Thus, when the first UE transmits to the second UE, the first UE's transmission timing is aligned with a frame timing derived by the first UE (from a time value at the first UE such as a GNSS time value). If the second UE transmits a sidelink transmission to the first UE, the second UE's transmission timing is aligned with a frame timing derived by the second UE (from a time value at the second UE such as a GNSS time value).

As shown, the first UE and the second UE may be associated with a communication link between the first UE and the second UE. For example, the communication link may be a sidelink, such as a sidelink unicast link. A sidelink unicast link may include a PC5 RRC link between the first UE and the second UE. Communications between the first UE and the second UE may occur on the communication link.

As further shown, in some examples, a range of the first UE and the second UE may satisfy a threshold. The range is a distance between the first UE and the second UE. In some aspects, the first UE or the second UE may determine the range as part of a discovery procedure. In some aspects, the first UE or the second UE may determine the range by performing ranging, such as by transmitting or receiving a reference signal that enables the first UE or the second UE to determine the range. In some aspects, the first UE or the second UE may determine the range based on a location of at least one of the first UE or the second UE (such as based on geographical coordinates of the first UE and/or the second UE, or based on a positioning operation using a reference signal transmission). For example, the first UE may receive an indication of the second UE's location, and the first UE may determine the range based on the second UE's location. The threshold may be based on a propagation delay between the first UE and the second UE, a pre-configured value, or a configured value.

In an operation 510, the first UE may identify a frame timing of the first UE based on a time value at the first UE. For example, the first UE may identify a DFN and a time associated with a slot boundary using the time value at the first UE. In some aspects, the time value is a GNSS time value, though other time values may be used (such as a time value derived from a synchronization signal block transmission by a network node).

As shown, the first UE may transmit a synchronization signal 520 to the second UE. For example, the first UE may transmit the synchronization signal 520 on the communication link between the first UE and the second UE. In some aspects, the synchronization signal 520 may be an S-SSB, such as a UE-specific S-SSB (that is, an S-SSB that carries information specific to a UE, such as a UE identifier). In some aspects, the synchronization signal 520 may include a preamble, such as a UE-specific preamble. For example, the preamble may include a sequence transmission prior to a sidelink control channel transmission or a sidelink data channel transmission.

In an operation 530, the second UE (in this example, the receiving UE) may synchronize to the frame timing of the first UE. For example, the second UE may detect the synchronization signal 520. The second UE may align a frame timing of the second UE based on the synchronization signal 520. For example, the second UE may offset the frame timing of the second UE by a time offset equal to a propagation delay derived from the synchronization signal 520. In this way, a sidelink transmission 540 by the first UE is received in alignment with slot and frame boundaries of the second UE.

Thus, the first UE (in this example, the transmitting UE) synchronizes a transmission timing with the second UE via the communication link with the second UE. The first UE may synchronize the transmission timing with the second UE by identifying a frame timing according to the time value at the first UE, and by transmitting the synchronization signal 520 on the communication link between the first UE and the second UE. The second UE may synchronize to the frame timing of the first UE (subject to propagation delay) based on the synchronization signal 520. Thus, the synchronization signal 520 is associated with synchronization, by the second UE, to the frame timing of the first UE.

As shown, the first UE may transmit a sidelink transmission 540 on the communication link to the second UE. For example, the first UE may transmit the sidelink transmission 540 using the frame timing according to the time value at the first UE. As shown, the first UE may transmit the sidelink transmission 540 with an offset 550 following the sidelink transmission. For example, the offset 550 may be a gap in which the first UE does not transmit a signal. The offset 550 may be after the sidelink transmission 540 when the frame timing is based on the time value at the first UE. In some aspects, a duration of the offset 550 is specific to the first UE. For example, the first UE may use a first duration for the offset 550 for transmissions of the first UE, and the second UE may use a different duration, a duration specific to the second UE, or no offset for transmissions of the second UE. In some aspects, a duration of the offset 550 is based on a maximum supported communication range of the first UE or the second UE. For example, the duration of the offset 550 may be equal to a propagation delay at the maximum supported communication range (which may be a maximum propagation delay allowed in the system). In this example, the duration of the offset 550 may be specified by a wireless communication specification, or may be configured or pre-configured from a set of specified values. Thus, inter-slot interference and inter-link interference are reduced.

In some aspects, a duration of the offset 550 is based on a range of the communication link. For example, the duration of the offset 550 may be equal to a propagation delay at the range between the first UE and the second UE. In some aspects, the second UE may transmit, to the first UE, information indicating the propagation delay or information indicating a duration of the offset 550. In some aspects, the second UE may transmit a synchronization signal using a time value (such as a GNSS time value) at the second UE. The first UE may detect the synchronization signal and may determine the duration of the offset 550 based on the frame timing at the first UE and the synchronization signal.

In some aspects, a duration of the offset 550 is based on a location of at least one of the first UE or the second UE. For example, the second UE may transmit, to the first UE, information (such as GNSS coordinates or a geographical zone index) indicating a location of the second UE. As another example, the first UE may transmit, to the second UE, information indicating a location of the first UE. The first UE or the second UE may use this information to determine a duration of an offset 550, such as by estimating a propagation delay between the first UE and the second UE based on locations of the first UE and the second UE.

In some aspects, a duration of the offset 550 is based at least in part on a switching time associated with switching between transmission and reception. For example, the duration of the offset 550 may be based at least in part on a turnaround time of the second UE (that is, a length of time needed for the second UE to switch from reception to transmission). In this example, if the timing difference or the propagation delay is determined as T1 and the turnaround time is determined as T2, the duration of the offset 550 may be determined to be no smaller than T1+T2.

In some aspects, the first UE may transmit, to the second UE, information indicating a duration of the offset 550. For example, the first UE may transmit a synchronization signal (such as the synchronization signal 520) indicating the duration. As another example, the first UE may transmit control signaling (such as SCI) indicating the duration to the second UE. In some aspects, the second UE may transmit information indicating a duration of the offset 550 to the first UE. For example, the second UE may transmit a feedback signal (such as a physical layer feedback signal or a medium access control control element (MAC-CE)) indicating the duration.

In some aspects, the duration of the offset 550 is at least as long as a duration of a propagation delay or a timing difference between the first UE and the second UE. For example, the duration may be in terms of a number of OFDM symbols. The number of OFDM symbols may be selected so that the duration of the offset 550 is at least as long as a duration of a propagation delay or a timing difference between the first UE and the second UE. For example, if the timing difference or the propagation delay is longer than 2 OFDM symbols but shorter than 3 OFDM symbols, the duration of the offset 550 may be determined to be 3 OFDM symbols.

In some aspects, the first UE may transmit an initial transmission to the second UE prior to synchronizing the transmission timing. The initial transmission may use an offset (referred to as an initial transmission offset) of a maximum length. For example, the maximum length may be equal to a maximum propagation delay allowed in the system. In some aspects, the initial transmission may be a transmission of the synchronization signal 520. In some aspects, the initial transmission may be a first data channel transmission (such as the sidelink transmission 540).

In an operation 560, the second UE may receive the sidelink transmission. For example, the second UE may receive the sidelink transmission with a reception timing that is based on the synchronization of the second UE's frame timing to the frame timing of the first UE. “Reception timing” refers to the time at which the sidelink transmission is received, and may be based on adjusting the second UE's frame timing in accordance with the synchronization signal 520 and the frame timing of the first UE.

FIG. 6 is a diagram illustrating an example 600 of synchronization based on a time value at a receiving UE in accordance with the present disclosure. FIG. 6 includes a first UE (such as UE 120, UE 305, UE 405, or UE 410), which is a transmitting UE, and a second UE (such as UE 120, UE 305, UE 405, or UE 410), which is a receiving UE. In the example of FIG. 6, the first UE and the second UE synchronize according to a time value at the second UE. FIG. 6 is an example of receiver-centric and per-direction synchronization. Thus, when the first UE transmits to the second UE, the first UE's transmission timing is aligned with a frame timing derived by the second UE (from a time value at the second UE such as a GNSS time value). If the second UE transmits a sidelink transmission to the first UE, the second UE's transmission timing is aligned with a frame timing derived by the first UE (from a time value at the first UE such as a GNSS time value).

As shown, the first UE and the second UE may be associated with a communication link between the first UE and the second UE. For example, the communication link may be a sidelink, such as a sidelink unicast link. A sidelink unicast link may include a PC5 RRC link between the first UE and the second UE. Communications between the first UE and the second UE may occur on the communication link.

As further shown, in some examples, a range of the first UE and the second UE may satisfy a threshold. The range is a distance between the first UE and the second UE. In some aspects, the first UE or the second UE may determine the range as part of a discovery procedure. In some aspects, the first UE or the second UE may determine the range by performing ranging, such as by transmitting or receiving a reference signal that enables the first UE or the second UE to determine the range. In some aspects, the first UE or the second UE may determine the range based on a location of at least one of the first UE or the second UE. For example, the first UE may receive an indication of the second UE's location, and the first UE may determine the range based on the second UE's location. The threshold may be based on a propagation delay between the first UE and the second UE or a pre-configured or configured value.

In an operation 610, the second UE may identify a frame timing of the first UE based on a time value at the second UE. For example, the second UE may identify a DFN and a time associated with a slot boundary using the time value at the second UE. In some aspects, the time value is a GNSS time value, though other time values may be used (such as a time value derived from a synchronization signal block transmission by a network node).

As shown, the second UE may transmit a synchronization signal 620 to the first UE. For example, the second UE may transmit the synchronization signal 620 on the communication link between the first UE and the second UE. In some aspects, the synchronization signal 620 may be an S-SSB, such as a UE-specific S-SSB. In some aspects, the synchronization signal 620 may include a preamble, such as a UE-specific preamble. For example, the preamble may include a sequence transmission prior to a sidelink control channel transmission or a sidelink data channel transmission.

In an operation 630, the first UE (in this example, the transmitting UE) may synchronize to the frame timing of the second UE. For example, the first UE may detect the synchronization signal 620. The first UE may align or determine a frame timing of the first UE based on the synchronization signal 620. For example, the first UE may offset the frame timing of the first UE by a time offset equal to a propagation delay derived from the synchronization signal 620. In this way, a transmission timing of a sidelink transmission 640 by the first UE is offset to be in alignment with slot and frame boundaries of the second UE.

Thus, the second UE (in this example, the receiving UE) synchronizes a reception timing with the first UE via the communication link with the second UE. The second UE may synchronize the reception timing with the first UE by identifying a frame timing according to the time value at the second UE, and by transmitting the synchronization signal 620 on the communication link between the first UE and the second UE. The first UE may synchronize to the frame timing of the second UE (subject to propagation delay) based on the synchronization signal 620. For example, the first UE may determine a transmission timing such that a reception time, of a sidelink transmission 640 at the second UE, is aligned with the frame timing of the second UE. Thus, the synchronization signal 620 is associated with synchronization, by the first UE, to the frame timing of the second UE.

As shown, the first UE may transmit a sidelink transmission 640 on the communication link to the second UE. For example, the first UE may transmit the sidelink transmission 640 using the frame timing according to the time value at the first UE. As shown, the first UE may transmit the sidelink transmission 640 with an offset 650 preceding the sidelink transmission. For example, the offset 650 may be a gap in which the first UE does not transmit a signal. The offset 650 may be before the sidelink transmission 640 when the first UE's transmission timing is determined, such that a reception time of the sidelink transmission 640 is aligned with the frame timing of the second UE.

In some aspects, the sidelink transmission 640 may include or be associated with SCI. The SCI may be mapped to (such as included in) one or more symbols that are known to the second UE, such that the second UE can decode the SCI in the one or more symbols. For example, a location of the one or more symbols may be pre-configured (such as by a network operator associated with the second UE), configured (such as using RRC signaling by the first UE, the second UE, or a network node), or pre-determined (such as in a wireless communication specification). In some aspects, the one or more symbols may not overlap with the offset 650. In some aspects, the location of the one or more symbols may be determined by the first UE (that is, the transmitting UE) and may be signaled to the second UE (that is, the receiving UE) by the first UE. For example, the first UE may transmit a synchronization signal (such as an S-SSB) indicating the location. In some aspects, the location of the one or more symbols may be determined by the second UE (that is, the receiving UE) and may be signaled to the first UE (that is, the transmitting UE) by the second UE. For example, the second UE may transmit a synchronization signal (such as an S-SSB or the synchronization signal 620) indicating the location.

In some aspects, a duration of the offset 650 is specific to the second UE. In some aspects, a duration of the offset 650 is based on a maximum supported communication range of the first UE or the second UE. For example, the duration of the offset 650 may be equal to a propagation delay at the maximum supported communication range (which may be a maximum propagation delay allowed in the system). In this example, the duration of the offset 650 may be specified by a wireless communication specification, or may be configured or pre-configured from a set of specified values. Thus, inter-slot interference and inter-link interference are reduced.

In some aspects, a duration of the offset 650 is based on a range of the communication link. For example, the duration of the offset 650 may be equal to a propagation delay at the range between the first UE and the second UE. In some aspects, the first UE may transmit, to the second UE, information indicating the propagation delay or information indicating a duration of the offset 650. In some aspects, the first UE may transmit a synchronization signal using a time value (such as a GNSS time value) at the first UE. The second UE may detect the synchronization signal and may determine the duration of the offset 650 based on the frame timing at the second UE and the synchronization signal.

In some aspects, a duration of the offset 650 is based on a location of at least one of the first UE or the second UE. For example, the second UE may transmit, to the first UE, information (such as GNSS coordinates or a geographical zone index) indicating a location of the second UE. As another example, the first UE may transmit, to the second UE, information indicating a location of the first UE. The first UE or the second UE may use this information to determine a duration of an offset 650, such as by estimating a propagation delay between the first UE and the second UE based on a location of the first UE and a location of the second UE.

In some aspects, a duration of the offset 650 is based at least in part on a switching time associated with switching between transmission and reception. For example, the duration of the offset 650 may be based at least in part on a turnaround time of the second UE (that is, a length of time needed for the second UE to switch from reception to transmission). In this example, if the timing difference or the propagation delay is determined as T1 and the turnaround time is determined as T2, the duration of the offset 650 may be determined to be no smaller than T1+T2.

In some aspects, the second UE may transmit, to the first UE, information indicating a duration of the offset 650. For example, the second UE may transmit a synchronization signal (such as the synchronization signal 620) indicating the duration. As another example, the second UE may transmit control signaling (such as SCI) indicating the duration to the first UE. As another example, the second UE may transmit a feedback signal (such as a physical layer feedback signal or a MAC-CE) indicating the duration.

In some aspects, the duration of the offset 650 is at least as long as a duration of a propagation delay or a timing difference between the first UE and the second UE. For example, the duration may be in terms of a number of OFDM symbols. The number of OFDM symbols may be selected so that the duration of the offset 650 is at least as long as a duration of a propagation delay or a timing difference between the first UE and the second UE. For example, if the timing difference or the propagation delay is longer than 2 OFDM symbols but shorter than 3 OFDM symbols, the duration of the offset 650 may be determined to be 3 OFDM symbols.

In some aspects, the first UE may transmit an initial transmission to the second UE prior to synchronizing the transmission timing. The initial transmission may use an offset (referred to as an initial transmission offset) of a maximum length. For example, the maximum length may be equal to a maximum propagation delay allowed in the system. In some aspects, the initial transmission may be a transmission of the synchronization signal 620. In some aspects, the initial transmission may be a first data channel transmission (such as the sidelink transmission 640).

In an operation 660, the second UE may receive the sidelink transmission. For example, the second UE may receive the sidelink transmission with a reception timing that is based on the synchronization of the second UE's frame timing to the frame timing of the first UE. “Reception timing” refers to the time at which the sidelink transmission is received (such as the time at which the second UE receives a channel carrying the sidelink transmission), and may be based on adjusting the first UE's frame timing and transmission timing in accordance with the synchronization signal 620 and the frame timing of the second UE. “Transmission timing” refers to a time at which the sidelink transmission is transmitted. In the example of FIG. 6, the first UE may advance the first UE's transmission timing based on propagation delay or timing difference between the first UE and the second UE. Thus, the second UE's receiving operation is simplified. For example, if the second UE receives sidelink transmissions from multiple transmitting UEs, the timings of the multiple transmissions are aligned at the second UE.

FIG. 7 is a diagram illustrating an example 700 of synchronization based on a time value at a selected UE in accordance with the present disclosure. FIG. 7 includes a first UE (such as UE 120, UE 305, UE 405, or UE 410), which is a transmitting UE, and a second UE (such as UE 120, UE 305, UE 405, or UE 410), which is a receiving UE. In the example of FIG. 7, the first UE and the second UE synchronize according to a time value at a selected UE, of the first UE and the second UE. In the example of FIG. 7, the selected UE is the first UE. When the first UE transmits to the second UE, the first UE's transmission timing is aligned with a frame timing derived by the first UE (such as based on a GNSS time value at the first UE). When the second UE transmits to the first UE, the second UE's transmission timing is advanced with respect to a frame timing derived by the second UE (such as based on a GNSS time value at the second UE) such that a reception timing at the first UE is aligned with the frame timing at the first UE. This can be contrasted with FIG. 5, where the first UE and the second UE synchronize to the transmitting UE's frame timing (whether the transmitting UE is the first UE or the second UE) and FIG. 6, where the first UE and the second UE synchronize to the receiving UE's frame timing (whether the receiving UE is the first UE or the second UE).

In some aspects, the first UE may be a head UE, such as a cluster head. For example, the first UE may be associated with a higher hierarchical level than the second UE in a hierarchical network. As another example, the first UE and the second UE may belong to a group of UEs, and the first UE may be a head UE of the group of UEs.

As shown, the first UE and the second UE may be associated with a communication link between the first UE and the second UE. For example, the communication link may be a sidelink, such as a sidelink unicast link. A sidelink unicast link may include a PC5 RRC link between the first UE and the second UE. Communications between the first UE and the second UE may occur on the communication link.

As further shown, in some aspects, a range of the first UE and the second UE may satisfy a threshold. The range is a distance between the first UE and the second UE. In some aspects, the first UE or the second UE may determine the range as part of a discovery procedure. In some aspects, the first UE or the second UE may determine the range by performing ranging, such as by transmitting or receiving a reference signal that enables the first UE or the second UE to determine the range. In some aspects, the first UE or the second UE may determine the range based on a location of at least one of the first UE or the second UE. For example, the first UE may receive an indication of the second UE's location, and the first UE may determine the range based on the second UE's location. The threshold may be based on a propagation delay between the first UE and the second UE or a pre-configured or configured value. In some aspects, the first UE or the second UE may determine the range as described in connection with FIG. 6.

In an operation 710, the first UE (that is, the selected UE) may identify a frame timing of the first UE based on a time value at the first UE. For example, the first UE may identify a DFN and a time associated with a slot boundary using the time value at the first UE. In some aspects, the time value is a GNSS time value, though other time values may be used (such as a time value derived from a synchronization signal block transmission by a network node).

As shown, the first UE (that is, the selected UE) may transmit a synchronization signal 720 to the second UE. For example, the first UE may transmit the synchronization signal 720 on the communication link between the first UE and the second UE. In some aspects, the synchronization signal 720 may be an S-SSB, such as a UE-specific S-SSB. In some aspects, the synchronization signal 720 may include a preamble, such as a UE-specific preamble. For example, the preamble may include a sequence transmission prior to a sidelink control channel transmission or a sidelink data channel transmission.

In an operation 730, the second UE may synchronize to the frame timing of the first UE. For example, the second UE may detect the synchronization signal 720. The second UE may align a frame timing of the second UE based on the synchronization signal 720. For example, the second UE may offset the frame timing of the second UE by a time offset equal to a propagation delay derived from the synchronization signal 720. As another example, the second UE may advance a transmission timing of the second UE by a time offset equal to the propagation delay. In this way, a sidelink transmission 740 by the first UE is received in alignment with slot and frame boundaries of the second UE.

Thus, the selected UE (in this example, the first UE) synchronizes a transmission timing with the second UE via the communication link with the second UE. The first UE may synchronize the transmission timing with the second UE by identifying a frame timing according to the time value at the first UE, and by transmitting the synchronization signal 720 on the communication link between the first UE and the second UE. The second UE may synchronize to the frame timing of the first UE (subject to propagation delay) based on the synchronization signal 720. Thus, the synchronization signal 720 is associated with synchronization, by the second UE, to the frame timing of the first UE.

As shown, the first UE may transmit a sidelink transmission 740 on the communication link to the second UE. For example, the first UE may transmit the sidelink transmission 740 using the frame timing according to the time value at the first UE. As shown, the first UE may transmit the sidelink transmission 740 with an offset 750. For example, the offset 750 may be a gap in which the first UE does not transmit a signal.

In some aspects, the offset 750 may be after the sidelink transmission 740. In some other aspects, the offset 750 may be before the sidelink transmission 740. For example, the offset 750 may be after the sidelink transmission 740 if the sidelink transmission 740 is based on a GNSS timing value (that is, if the sidelink transmission 740 is transmitted by the selected UE). As another example, the offset 750 may be before a sidelink transmission if the sidelink transmission uses an advanced transmission timing (that is, if a transmission timing of the sidelink transmission, as transmitted by the second UE other than the selected UE, is advanced based on a timing value at the selected UE and a propagation delay).

In some aspects, a sidelink transmission 740 by the selected UE has an offset 750 that is based on a maximum supported communication range of the selected UE. For example, the duration of the offset 750 may be equal to a propagation delay at the maximum supported communication range (which may be a maximum propagation delay allowed in the system). In this example, the duration of the offset 750 may be specified by a wireless communication specification, or may be configured or pre-configured from a set of specified values. Thus, inter-slot interference and inter-link interference are reduced. In some aspects, a sidelink transmission 760 by a second UE, other than the selected UE, does not have an offset. For example, the sidelink transmission 760 may be a full slot transmission. In some aspects, the sidelink transmission 760 may have a switching gap, such as a switching gap based on a transmission to reception switching time of the selected UE. In an operation 770, a transmission timing of the sidelink transmission 760 may be advanced, such as to align reception of the sidelink transmission 760, at the selected UE, with a frame timing of the selected UE.

In some aspects, a duration of the offset 750 is based on a range of the communication link. For example, the duration of the offset 750 may be equal to a propagation delay at the range between the first UE and the second UE. In some aspects, the second UE may transmit, to the first UE, information indicating the propagation delay or information indicating a duration of the offset 750. In some aspects, the second UE may transmit a synchronization signal using a time value (such as a GNSS time value) at the second UE. The first UE may detect the synchronization signal and may determine the duration of the offset 750 based on the frame timing at the first UE and the synchronization signal.

In some aspects, a duration of the offset 750 is based on a location of at least one of the first UE or the second UE. For example, the second UE may transmit, to the first UE, information (such as GNSS coordinates or a geographical zone index) indicating a location of the second UE. As another example, the first UE may transmit, to the second UE, information indicating a location of the first UE. The first UE or the second UE may use this information to determine a duration of an offset 750, such as by estimating a propagation delay between the first UE and the second UE based on locations of the first UE and the second UE.

In some aspects, a duration of the offset 750 is based at least in part on a switching time associated with switching between transmission and reception. For example, the duration of the offset 750 may be based at least in part on a turnaround time of the second UE (that is, a length of time needed for the second UE to switch from reception to transmission). In this example, if the timing difference or the propagation delay is determined as T1 and the turnaround time is determined as T2, the duration of the offset 750 may be determined to be no smaller than T1+T2.

In some aspects, the first UE may transmit, to the second UE, information indicating a duration of the offset 750. For example, the first UE may transmit a synchronization signal (such as the synchronization signal 720) indicating the duration. As another example, the first UE may transmit control signaling (such as SCI) indicating the duration to the second UE. In some aspects, the second UE may transmit information indicating a duration of the offset 750 to the first UE. For example, the second UE may transmit a feedback signal (such as a physical layer feedback signal or a MAC-CE) indicating the duration.

In some aspects, the duration of the offset 750 is at least as long as a duration of a propagation delay or a timing difference between the first UE and the second UE. For example, the duration may be in terms of a number of OFDM symbols. The number of OFDM symbols may be selected so that the duration of the offset 750 is at least as long as a duration of a propagation delay or a timing difference between the first UE and the second UE. For example, if the timing difference or the propagation delay is longer than 2 OFDM symbols but shorter than 3 OFDM symbols, the duration of the offset 750 may be determined to be 3 OFDM symbols.

In some aspects, the first UE may transmit an initial transmission to the second UE prior to synchronizing the transmission timing. The initial transmission may use an offset (referred to as an initial transmission offset) of a maximum length. For example, the maximum length may be equal to a maximum propagation delay allowed in the system. In some aspects, the initial transmission may be a transmission of the synchronization signal 720. In some aspects, the initial transmission may be a first data channel transmission (such as the sidelink transmission 740).

In some aspects, the second UE may receive the sidelink transmission. For example, the second UE may receive the sidelink transmission with a reception timing that is based on the synchronization of the second UE's frame timing to the frame timing of the selected UE (in this example, the first UE).

In some aspects (such as in the examples of FIGS. 5, 6, and 7), a transmitting UE may transmit an indication that slot aggregation is enabled. For example, the transmitting UE may dynamically enable or disable slot aggregation, such as via an indication in SCI. “Slot aggregation” refers to the transmission of the same transport block across multiple slots. For example, a transmission of a single transport block may span multiple slots. In some aspects, slot aggregation may be enabled or disabled based on a duration of an offset (such as offset 550, 650, or 750). For example, slot aggregation may be enabled when a duration of the offset is lower than a threshold, to ensure at least X symbols are available for the sidelink transmission. For example, if X is 10, then slot aggregation may be enabled if a duration of the offset is greater than or equal to 4 symbols. The receiving UE may receive a sidelink transmission using slot aggregation if slot aggregation is enabled.

FIG. 8 is a flowchart illustrating an example process 800 performed, for example, by a first UE in accordance with the present disclosure. Example process 800 is an example where the first UE (for example, UE 120, UE 305, UE 405, UE 410, or the first UE of FIG. 5, 6, or 7) performs operations associated with synchronized long range sidelink communication.

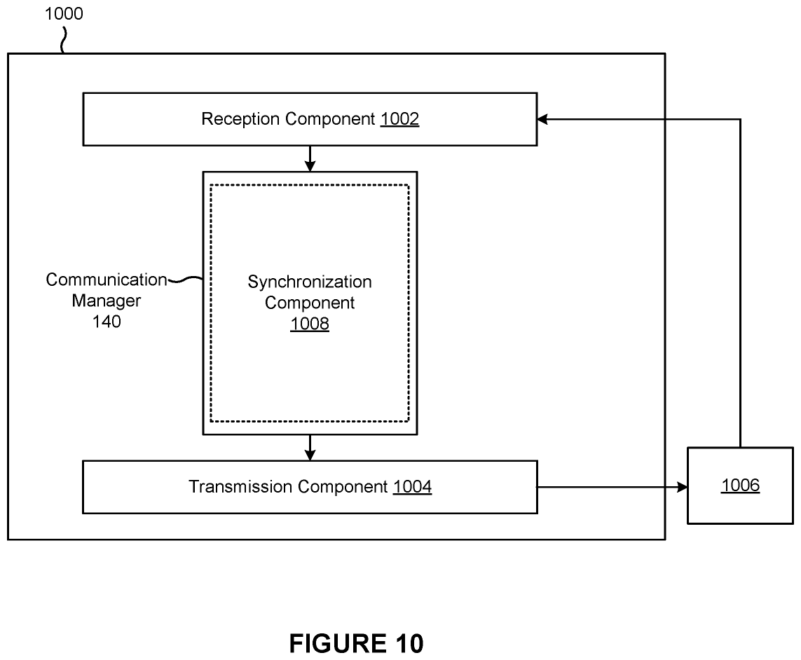

As shown in FIG. 8, in some aspects, process 800 may include synchronizing a transmission timing with a second UE via a communication link with the second UE (block 810). For example, the first UE (such as by using communication manager 140 or synchronization component 1008, depicted in FIG. 10) may synchronize a transmission timing with the second UE via a communication link with the second UE, as described above.

As further shown in FIG. 8, in some aspects, process 800 may include transmitting a sidelink transmission on the communication link with an offset before or after the sidelink transmission and in accordance with the transmission timing (block 820). For example, the first UE (such as by using communication manager 140 or transmission component 1004, depicted in FIG. 10) may transmit a sidelink transmission on the communication link with an offset before or after the sidelink transmission and in accordance with the transmission timing, as described above. In some aspects, a duration of the offset is based at least in part on a propagation delay between the first UE and the second UE, a maximum supported communication range of the first UE, or a range associated with the communication link.

Process 800 may include additional aspects, such as any single aspect or any combination of aspects described below or in connection with one or more other processes described elsewhere herein.

In a first additional aspect, the duration of the offset is based at least in part on a propagation delay between the first UE and the second UE, a maximum supported communication range of the first UE, or a range associated with the communication link.

In a second additional aspect, alone or in combination with the first aspect, the duration of the offset is specific to the first UE.

In a third additional aspect, alone or in combination with one or more of the first and second aspects, the duration of the offset is specific to the communication link.

In a fourth additional aspect, alone or in combination with one or more of the first through third aspects, the duration of the offset is at least as long as a duration of the propagation delay or a timing difference between the first UE and the second UE.

In a fifth additional aspect, alone or in combination with one or more of the first through fourth aspects, a duration of the offset is based at least in part on a switching time associated with switching between transmission and reception.

In a sixth additional aspect, alone or in combination with one or more of the first through fifth aspects, the synchronization of the transmission timing with the second UE further comprises identifying a frame timing of the first UE based at least in part on a time value at the first UE, and transmitting a synchronization signal associated with synchronization to the frame timing of the first UE.

In a seventh additional aspect, alone or in combination with one or more of the first through sixth aspects, the offset is after the sidelink transmission when the frame timing is based at least in part on the time value at the first UE.

In an eighth additional aspect, alone or in combination with one or more of the first through seventh aspects, the synchronization signal indicates a location of the first UE.

In a ninth additional aspect, alone or in combination with one or more of the first through eighth aspects, the synchronization of the transmission timing with the second UE further comprises determining the transmission timing such that a reception time, of the sidelink transmission at the second UE, is aligned with a frame timing of the second UE.

In a tenth additional aspect, alone or in combination with one or more of the first through ninth aspects, the offset is before the sidelink transmission when the transmission timing is determined such that the reception time is aligned with the frame timing of the second UE.

In an eleventh additional aspect, alone or in combination with one or more of the first through tenth aspects, process 800 includes receiving a synchronization signal from the second UE, wherein determining the transmission timing is based at least in part on the synchronization signal.

In a twelfth additional aspect, alone or in combination with one or more of the first through eleventh aspects, the synchronization of the transmission timing with the second UE further comprises synchronizing the transmission timing according to a time value at a selected UE of the first UE and the second UE.

In a thirteenth additional aspect, alone or in combination with one or more of the first through twelfth aspects, the selected UE is the first UE, and process 800 includes transmitting a synchronization signal associated with synchronization, by the second UE, to a frame timing of the first UE.

In a fourteenth additional aspect, alone or in combination with one or more of the first through thirteenth aspects, the offset is a first offset and the sidelink transmission is a first sidelink transmission, and process 800 includes receiving a second sidelink transmission from the second UE, wherein the second sidelink transmission is not associated with a second offset.

In a fifteenth additional aspect, alone or in combination with one or more of the first through fourteenth aspects, the selected UE is the second UE, and process 800 includes receiving a synchronization signal from the second UE, wherein synchronizing the transmission timing with the second UE further comprises advancing a transmission timing of the sidelink transmission according to a frame timing of the second UE.

In a sixteenth additional aspect, alone or in combination with one or more of the first through fifteenth aspects, the selected UE is a head UE.

In a seventeenth additional aspect, alone or in combination with one or more of the first through sixteenth aspects, the sidelink transmission includes sidelink control information in a pre-configured location.

In an eighteenth additional aspect, alone or in combination with one or more of the first through seventeenth aspects, the sidelink transmission includes sidelink control information and the method further comprises transmitting, to the second UE, an indication of a location of the sidelink control information.

In a nineteenth additional aspect, alone or in combination with one or more of the first through eighteenth aspects, the sidelink transmission includes sidelink control information and process 800 includes receiving, from the second UE, an indication of a location of the sidelink control information.

In a twentieth additional aspect, alone or in combination with one or more of the first through nineteenth aspects, process 800 includes transmitting, to the second UE, an indication that slot aggregation is enabled.

In a twenty-first additional aspect, alone or in combination with one or more of the first through twentieth aspects, the transmission of the sidelink transmission further comprises transmitting the sidelink transmission using slot aggregation based at least in part on a duration of the offset satisfying a threshold.

In a twenty-second additional aspect, alone or in combination with one or more of the first through twenty-first aspects, process 800 includes transmitting, prior to synchronizing the transmission timing, an initial transmission to the second UE, wherein the initial transmission is associated with an initial transmission offset of a maximum length.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, by a first UE in accordance with the present disclosure. Example process 900 is an example where the first UE (for example, UE 120, UE 305, UE 405, UE 410, the second UE of FIG. 5, 6, or 7) performs operations associated with synchronized long range sidelink communication.

As shown in FIG. 9, in some aspects, process 900 may include synchronizing a reception timing with the second UE via a communication link with the second UE (block 910). For example, the first UE (such as by using communication manager 140 or synchronization component 1008, depicted in FIG. 10) may synchronize a reception timing with the second UE via a communication link with the second UE, as described above.

As further shown in FIG. 9, in some aspects, process 900 may include receiving a sidelink transmission on the communication link with an offset before or after the sidelink transmission and in accordance with the reception timing (block 920). For example, the first UE (such as by using communication manager 140 or reception component 1002, depicted in FIG. 10) may receive a sidelink transmission on the communication link with an offset before or after the sidelink transmission and in accordance with the reception timing, as described above. In some aspects, a duration of the offset is based at least in part on a propagation delay between the first UE and the second UE, a maximum supported communication range of the first UE, or a range associated with the communication link. In some aspects, synchronizing the reception timing with the second UE is based at least in part on the range satisfying a threshold.

Process 900 may include additional aspects, such as any single aspect or any combination of aspects described below or in connection with one or more other processes described elsewhere herein.

In a first additional aspect, the synchronization of the reception timing with the second UE further comprises synchronizing the reception timing with the second UE based at least in part on the communication link with the second UE.

In a second additional aspect, alone or in combination with the first aspect, a duration of the offset is based at least in part on a propagation delay between the first UE and the second UE, a maximum supported communication range of the second UE, or a range associated with the communication link.

In a third additional aspect, alone or in combination with one or more of the first and second aspects, a duration of the offset is based at least in part on the first UE.

In a fourth additional aspect, alone or in combination with one or more of the first through third aspects, a duration of the offset is specific to the communication link.

In a fifth additional aspect, alone or in combination with one or more of the first through fourth aspects, a duration of the offset is at least as long as a duration of a propagation delay or a timing difference between the first UE and the second UE.

In a sixth additional aspect, alone or in combination with one or more of the first through fifth aspects, a duration of the offset is based at least in part on a switching time associated with switching between transmission and reception.

In a seventh additional aspect, alone or in combination with one or more of the first through sixth aspects, the synchronization of the reception timing with the second UE further comprises receiving a synchronization signal, and synchronizing the reception timing of the first UE with a frame timing of the second UE based at least in part on the synchronization signal.

In an eighth additional aspect, alone or in combination with one or more of the first through seventh aspects, the offset is before the sidelink transmission when the frame timing is based at least in part on the frame timing of the second UE.

In a ninth additional aspect, alone or in combination with one or more of the first through eighth aspects, the synchronization signal indicates a location of the second UE, and a duration of the offset is based at least in part on the location of the second UE.

In a tenth additional aspect, alone or in combination with one or more of the first through ninth aspects, the synchronization of the reception timing with the second UE further comprises identifying a frame timing of the first UE based at least in part on a time value at the first UE, and transmitting a synchronization signal associated with synchronization to the frame timing of the first UE.

In an eleventh additional aspect, alone or in combination with one or more of the first through tenth aspects, the offset is after the sidelink transmission when the reception timing is determined based at least in part on the time value at the first UE.

In a twelfth additional aspect, alone or in combination with one or more of the first through eleventh aspects, the sidelink transmission includes sidelink control information in a pre-configured location.

In a thirteenth additional aspect, alone or in combination with one or more of the first through twelfth aspects, the sidelink transmission includes sidelink control information and process 900 includes receiving, from the second UE, an indication of a location of the sidelink control information.

In a fourteenth additional aspect, alone or in combination with one or more of the first through thirteenth aspects, the synchronization of the reception timing with the second UE further comprises synchronizing the reception timing according to a time value at a selected UE of the first UE and the second UE.

In a fifteenth additional aspect, alone or in combination with one or more of the first through fourteenth aspects, the selected UE is the second UE, and process 900 includes receiving a synchronization signal associated with synchronization, by the first UE, to a frame timing of the second UE, wherein synchronizing the reception timing further comprises synchronizing the reception timing based at least in part on the synchronization signal.

In a sixteenth additional aspect, alone or in combination with one or more of the first through fifteenth aspects, the offset is a first offset and the sidelink transmission is a first sidelink transmission, and process 900 includes transmitting a second sidelink transmission to the second UE, wherein the second sidelink transmission is not associated with a second offset.

In a seventeenth additional aspect, alone or in combination with one or more of the first through sixteenth aspects, the selected UE is the first UE, and process 900 includes transmitting a synchronization signal to the second UE indicating a frame timing of the first UE.

In an eighteenth additional aspect, alone or in combination with one or more of the first through seventeenth aspects, the selected UE is a head UE.

In a nineteenth additional aspect, alone or in combination with one or more of the first through eighteenth aspects, process 900 includes receiving, from the second UE, an indication that slot aggregation is enabled.

In a twentieth additional aspect, alone or in combination with one or more of the first through nineteenth aspects, the reception of the sidelink transmission further comprises receiving the sidelink transmission using slot aggregation based at least in part on a duration of the offset satisfying a threshold.

In a twenty-first additional aspect, alone or in combination with one or more of the first through twentieth aspects, process 900 includes receiving, prior to synchronizing the reception timing, an initial transmission from the second UE, wherein the initial transmission is associated with an initial transmission offset of a maximum length.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication in accordance with the present disclosure. The apparatus 1000 may be a first UE, or a first UE may include the apparatus 1000. In some aspects, the apparatus 1000 includes a reception component 1002, a transmission component 1004, and a communication manager 140, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to perform one or more operations described herein in connection with FIGS. 3-7. Additionally or alternatively, the apparatus 1000 may be configured to perform one or more processes described herein, such as process 800 of FIG. 8 or process 900 of FIG. 9, or a combination thereof. In some aspects, the apparatus 1000 may include one or more components of the first UE described above in connection with FIG. 2.

The reception component 1002 may receive communications, such as reference signals, control information, data communications, or a combination thereof, from the apparatus 1006. The reception component 1002 may provide received communications to one or more other components of the apparatus 1000, such as the communication manager 140. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, a modem, a demodulator, a MIMO detector, a receive processor, a controller/processor, a memory, or a combination thereof, of the first UE described above in connection with FIG. 2.

The transmission component 1004 may transmit communications, such as reference signals, control information, data communications, or a combination thereof, to the apparatus 1006. In some aspects, the communication manager 140 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the first UE described above in connection with FIG. 2. In some aspects, the transmission component 1004 may be co-located with the reception component 1002 in a transceiver.

In some examples (as described with regard to the process 800 of FIG. 8), the communication manager 140 may synchronize a transmission timing with the second UE via a communication link with the second UE based at least in part on a range of the first UE and the second UE satisfying a threshold. The communication manager 140 may transmit or may cause the transmission component 1004 to transmit a sidelink transmission on the communication link with an offset before or after the sidelink transmission and in accordance with the transmission timing based at least in part on the range satisfying the threshold. In some aspects, the communication manager 140 may perform one or more operations described elsewhere herein as being performed by one or more components of the communication manager 140.

In some examples (as described with regard to the process 900 of FIG. 9), the communication manager 140 may synchronize a reception timing with the second UE via a communication link with the second UE based at least in part on a range of the first UE and the second UE satisfying a threshold. The communication manager 140 may receive or may cause the reception component 1002 to receive a sidelink transmission on the communication link with an offset before or after the sidelink transmission and in accordance with the reception timing based at least in part on the range satisfying the threshold. In some aspects, the communication manager 140 may perform one or more operations described elsewhere herein as being performed by one or more components of the communication manager 140.

The communication manager 140 may include a controller/processor, a memory, a scheduler, a communication unit, or a combination thereof, of the first UE described above in connection with FIG. 2. In some aspects, the communication manager 140 includes a set of components, such as a synchronization component 1008, or a combination thereof. Alternatively, the set of components may be separate and distinct from the communication manager 140. In some aspects, one or more components of the set of components may include or may be implemented within a controller/processor, a memory, a scheduler, a communication unit, or a combination thereof, of the first UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The synchronization component 1008 may synchronize a transmission timing with the second UE via a communication link with the second UE based at least in part on a range of the first UE and the second UE satisfying a threshold. The transmission component 1004 may transmit a sidelink transmission on the communication link with an offset before or after the sidelink transmission and in accordance with the transmission timing based at least in part on the range satisfying the threshold.

The reception component 1002 may receive a synchronization signal from the second UE, wherein determining the transmission timing is based at least in part on the synchronization signal.

The transmission component 1004 may transmit, to the second UE, an indication that slot aggregation is enabled.

The transmission component 1004 may transmit, prior to synchronizing the transmission timing, an initial transmission to the second UE, wherein the initial transmission is associated with an initial transmission offset of a maximum length.

The synchronization component 1008 may synchronize a reception timing with the second UE via a communication link with the second UE based at least in part on a range of the first UE and the second UE satisfying a threshold. The reception component 1002 may receive a sidelink transmission on the communication link with an offset before or after the sidelink transmission and in accordance with the reception timing based at least in part on the range satisfying the threshold.

The reception component 1002 may receive, from the second UE, an indication that slot aggregation is enabled.

The reception component 1002 may receive, prior to synchronizing the reception timing, an initial transmission from the second UE, wherein the initial transmission is associated with an initial transmission offset of a maximum length.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first user equipment (UE), comprising: synchronizing a transmission timing with a second UE via a communication link with the second UE; and transmitting a sidelink transmission on the communication link with an offset before or after the sidelink transmission and in accordance with the transmission timing, wherein a duration of the offset is based at least in part on a propagation delay between the first UE and the second UE, a maximum supported communication range of the first UE, or a range associated with the communication link.

Aspect 2: The method of Aspect 1, wherein synchronizing the transmission timing with the second UE is based at least in part on the range satisfying a threshold.

Aspect 3: The method of any of Aspects 1-2, wherein the duration of the offset is specific to the first UE.

Aspect 4: The method of any of Aspects 1-3, wherein the duration of the offset is specific to the communication link.

Aspect 5: The method of any of Aspects 1-4, wherein the duration of the offset is at least as long as a duration of the propagation delay or a timing difference between the first UE and the second UE.

Aspect 6: The method of any of Aspects 1-5, wherein a duration of the offset is based at least in part on a switching time associated with switching between transmission and reception.

Aspect 7: The method of any of Aspects 1-6, wherein the synchronization of the transmission timing with the second UE further comprises: identifying a frame timing of the first UE based at least in part on a time value at the first UE; and transmitting a synchronization signal associated with synchronization, by the second UE, to the frame timing of the first UE.

Aspect 8: The method of Aspect 7, wherein the offset is after the sidelink transmission when the frame timing is based at least in part on the time value at the first UE.

Aspect 9: The method of Aspect 7, wherein the synchronization signal indicates a location of the first UE.

Aspect 10: The method of any of Aspects 1-9, wherein the synchronization of the transmission timing with the second UE further comprises determining the transmission timing such that a reception time, of the sidelink transmission at the second UE, is aligned with a frame timing of the second UE.

Aspect 11: The method of Aspect 10, wherein the offset is before the sidelink transmission when the transmission timing is determined such that the reception time is aligned with the frame timing of the second UE.

Aspect 12: The method of Aspect 10, further comprising receiving a synchronization signal from the second UE, wherein determining the transmission timing is based at least in part on the synchronization signal.

Aspect 13: The method of any of Aspects 1-12, wherein the synchronization of the transmission timing with the second UE further comprises synchronizing the transmission timing according to a time value at a selected UE of the first UE and the second UE.

Aspect 14: The method of Aspect 13, wherein the selected UE is the first UE, and wherein the method further comprises transmitting a synchronization signal associated with synchronization, by the second UE, to a frame timing of the first UE.

Aspect 15: The method of Aspect 14, wherein the offset is a first offset and the sidelink transmission is a first sidelink transmission, and wherein the method further comprises receiving a second sidelink transmission from the second UE, wherein the second sidelink transmission is not associated with a second offset.

Aspect 16: The method of Aspect 15, wherein the selected UE is the second UE and the method further comprises receiving a synchronization signal from the second UE, wherein synchronizing the transmission timing with the second UE further comprises advancing a transmission timing of the sidelink transmission according to a frame timing of the second UE.

Aspect 17: The method of Aspect 15, wherein the selected UE is a head UE.

Aspect 18: The method of any of Aspects 1-17, wherein the sidelink transmission includes sidelink control information in a pre-configured location.

Aspect 19: The method of any of Aspects 1-18, wherein the sidelink transmission includes sidelink control information and the method further comprises transmitting, to the second UE, an indication of a location of the sidelink control information.

Aspect 20: The method of any of Aspects 1-19, wherein the sidelink transmission includes sidelink control information and the method further comprises receiving, from the second UE, an indication of a location of the sidelink control information.

Aspect 21: The method of any of Aspects 1-20, further comprising transmitting, to the second UE, an indication that slot aggregation is enabled.

Aspect 22: The method of any of Aspects 1-21, wherein the transmission of the sidelink transmission further comprises transmitting the sidelink transmission using slot aggregation based at least in part on a duration of the offset satisfying a threshold.

Aspect 23: The method of any of Aspects 1-22, further comprising transmitting, prior to synchronizing the transmission timing, an initial transmission to the second UE, wherein the initial transmission is associated with an initial transmission offset of a maximum length.

Aspect 24: A method of wireless communication performed by a first user equipment (UE), comprising: synchronizing a reception timing with a second UE via a communication link with the second UE; and receiving a sidelink transmission on the communication link with an offset before or after the sidelink transmission and in accordance with the reception timing, wherein a duration of the offset is based at least in part on a propagation delay between the first UE and the second UE, a maximum supported communication range of the second UE, or a range associated with the communication link.

Aspect 25: The method of Aspect 24, wherein the synchronization of the reception timing with the second UE further comprises synchronizing the reception timing with the second UE based at least in part on the communication link with the second UE.

Aspect 26: The method of any of Aspects 24-25, wherein synchronizing the reception timing with the second UE is based at least in part on the range satisfying a threshold.

Aspect 27: The method of any of Aspects 24-26, wherein the duration of the offset is based at least in part on the first UE.

Aspect 28: The method of any of Aspects 24-27, wherein the duration of the offset is specific to the communication link.

Aspect 29: The method of any of Aspects 24-28, wherein the duration of the offset is at least as long as a duration of a propagation delay or a timing difference between the first UE and the second UE.

Aspect 30: The method of any of Aspects 24-29, wherein the duration of the offset is based at least in part on a switching time associated with switching between transmission and reception.

Aspect 31: The method of any of Aspects 24-30, wherein the synchronization of the reception timing with the second UE further comprises: receiving a synchronization signal; and synchronizing the reception timing of the first UE with a frame timing of the second UE based at least in part on the synchronization signal.

Aspect 32: The method of Aspect 31, wherein the offset is before the sidelink transmission when the frame timing is based at least in part on the frame timing of the second UE.

Aspect 33: The method of Aspect 31, wherein the synchronization signal indicates a location of the second UE, and wherein a duration of the offset is based at least in part on the location of the second UE.

Aspect 34: The method of any of Aspects 24-33, wherein the synchronization of the reception timing with the second UE further comprises: identifying a frame timing of the first UE based at least in part on a time value at the first UE; and transmitting a synchronization signal associated with synchronization, by the second UE, to the frame timing of the first UE.

Aspect 35: The method of Aspect 34, wherein the offset is after the sidelink transmission when the reception timing is determined based at least in part on the time value at the first UE.

Aspect 36: The method of any of Aspects 24-35, wherein the sidelink transmission includes sidelink control information in a pre-configured location.

Aspect 37: The method of any of Aspects 24-36, wherein the sidelink transmission includes sidelink control information and the method further comprises receiving, from the second UE, an indication of a location of the sidelink control information.

Aspect 38: The method of any of Aspects 24-37, wherein the synchronization of the reception timing with the second UE further comprises synchronizing the reception timing according to a time value at a selected UE of the first UE and the second UE.

Aspect 39: The method of Aspect 38, wherein the selected UE is the second UE, and wherein the method further comprises receiving a synchronization signal associated with synchronization, by the first UE, to a frame timing of the second UE, wherein synchronizing the reception timing further comprises synchronizing the reception timing based at least in part on the synchronization signal.

Aspect 40: The method of Aspect 39, wherein the offset is a first offset and the sidelink transmission is a first sidelink transmission, and wherein the method further comprises transmitting a second sidelink transmission to the second UE, wherein the second sidelink transmission is not associated with a second offset.

Aspect 41: The method of Aspect 38, wherein the selected UE is the first UE, and wherein the method further comprises transmitting a synchronization signal to the second UE indicating a frame timing of the first UE.

Aspect 42: The method of Aspect 38, wherein the selected UE is a head UE.

Aspect 43: The method of any of Aspects 24-42, further comprising receiving, from the second UE, an indication that slot aggregation is enabled.

Aspect 44: The method of any of Aspects 24-43, wherein the reception of the sidelink transmission further comprises receiving the sidelink transmission using slot aggregation based at least in part on a duration of the offset satisfying a threshold.

Aspect 45: The method of any of Aspects 24-44, further comprising receiving, prior to synchronizing the reception timing, an initial transmission from the second UE, wherein the initial transmission is associated with an initial transmission offset of a maximum length.

Aspect 46: An apparatus for wireless communication at a device, comprising a processor; memory coupled with the processor; and instructions stored in the memory and executable by the processor to cause the apparatus to perform the method of one or more of Aspects 1-45.

Aspect 47: A device for wireless communication, comprising a memory and one or more processors coupled to the memory, the one or more processors configured to perform the method of one or more of Aspects 1-45.

Aspect 48: An apparatus for wireless communication, comprising at least one means for performing the method of one or more of Aspects 1-45.

Aspect 49: A non-transitory computer-readable medium storing code for wireless communication, the code comprising instructions executable by a processor to perform the method of one or more of Aspects 1-45.

Aspect 50: A non-transitory computer-readable medium storing a set of instructions for wireless communication, the set of instructions comprising one or more instructions that, when executed by one or more processors of a device, cause the device to perform the method of one or more of Aspects 1-45.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A first user equipment (UE) for wireless communication, comprising:
at least one memory; and
at least one processor communicatively coupled with the at least one memory, the at least one processor configured to cause the UE to:
synchronize a transmission timing with a second UE via a communication link with the second UE; and
transmit a sidelink transmission on the communication link with an offset before or after the sidelink transmission and in accordance with the transmission timing, wherein a duration of the offset is based at least in part on a propagation delay between the first UE and the second UE, a maximum supported communication range of the first UE, or a range associated with the communication link.

2. The first UE of claim 1, wherein synchronizing the transmission timing with the second UE is based at least in part on the range satisfying a threshold.

3. The first UE of claim 1, wherein the duration of the offset is specific to the first UE.

4. The first UE of claim 1, wherein the duration of the offset is specific to the communication link.

5. The first UE of claim 1, wherein the duration of the offset is at least as long as a duration of the propagation delay or a timing difference between the first UE and the second UE.

6. The first UE of claim 1, wherein the duration of the offset is based at least in part on a switching time associated with switching between transmission and reception.

7. The first UE of claim 1, wherein the at least one processor, to cause the first UE to synchronize the transmission timing with the second UE, is configured to cause the first UE to:
identify a frame timing of the first UE based at least in part on a time value at the first UE; and
transmit a synchronization signal associated with synchronization to the frame timing of the first UE.

8. The first UE of claim 7, wherein the offset is after the sidelink transmission when the frame timing is based at least in part on the time value at the first UE.

9. The first UE of claim 7, wherein the synchronization signal indicates a location of the first UE.

10. The first UE of claim 1, wherein the at least one processor, to cause the first UE to synchronize the transmission timing with the second UE, is configured to cause the first UE to determine the transmission timing such that a reception time, of the sidelink transmission at the second UE, is aligned with a frame timing of the second UE.

11. The first UE of claim 10, wherein the offset is before the sidelink transmission when the transmission timing is determined such that the reception time is aligned with the frame timing of the second UE.

12. The first UE of claim 10, wherein the at least one processor is further configured to cause the first UE to receive a synchronization signal from the second UE, wherein determining the transmission timing is based at least in part on the synchronization signal.

13. The first UE of claim 1, wherein the at least one processor, to cause the first UE to synchronize the transmission timing with the second UE, is configured to cause the UE to synchronize the transmission timing according to a time value at a selected UE of the first UE and the second UE.

14. The first UE of claim 13, wherein the selected UE is the first UE, and wherein the at least one processor is further configured to cause the first UE to transmit a synchronization signal associated with synchronization, by the second UE, to a frame timing of the first UE.

15. The first UE of claim 14, wherein the offset is a first offset and the sidelink transmission is a first sidelink transmission, and wherein the at least one processor is further configured to cause the first UE to receive a second sidelink transmission from the second UE, wherein the second sidelink transmission is not associated with a second offset.

16. The first UE of claim 15, wherein the selected UE is the second UE and the at least one processor is further configured to cause the first UE to receive a synchronization signal from the second UE, wherein the at least one processor, to cause the first UE to synchronize the transmission timing with the second UE, is configured to cause the first UE to advance a transmission timing of the sidelink transmission according to a frame timing of the second UE.

17. The first UE of claim 15, wherein the selected UE is a head UE.

18. The first UE of claim 1, wherein the sidelink transmission includes sidelink control information in a pre-configured location.

19. The first UE of claim 1, wherein the sidelink transmission includes sidelink control information and the least one processor is further configured to cause the first UE to transmit, to the second UE, an indication of a location of the sidelink control information.

20. A first user equipment (UE) for wireless communication, comprising:
at least one memory; and
at least one processor communicatively coupled with the at least one memory, the at least one processor configured to cause the first UE to:
synchronize a reception timing with a second UE via a communication link with the second UE; and
receive a sidelink transmission on the communication link with an offset before or after the sidelink transmission and in accordance with the reception timing, wherein a duration of the offset is based at least in part on a propagation delay between the first UE and the second UE, a maximum supported communication range of the second UE, or a range associated with the communication link.

21. The first UE of claim 20, wherein synchronizing the reception timing is based at least in part on the range satisfying a threshold.

22. The first UE of claim 20, wherein the at least one processor, to cause the first UE to synchronize the reception timing with the second UE, is configured to cause the first UE to:
receive a synchronization signal; and
synchronize the reception timing of the first UE with a frame timing of the second UE based at least in part on the synchronization signal.

23. The first UE of claim 22, wherein the offset is before the sidelink transmission when the frame timing is based at least in part on the frame timing of the second UE.

24. The first UE of claim 20, wherein the at least one processor, to cause the first UE to synchronize the reception timing with the second UE, is configured to cause the first UE to:
identify a frame timing of the first UE based at least in part on a time value at the first UE; and
transmit a synchronization signal associated with synchronization to the frame timing of the first UE.

25. A method of wireless communication performed by a first user equipment (UE), comprising:
synchronizing a transmission timing with a second UE via a communication link with the second UE; and
transmitting a sidelink transmission on the communication link with an offset before or after the sidelink transmission and in accordance with the transmission timing, wherein a duration of the offset is based at least in part on a propagation delay between the first UE and the second UE, a maximum supported communication range of the first UE, or a range associated with the communication link.

26. The method of claim 25, wherein synchronizing the transmission timing with the second UE is based at least in part on the range satisfying a threshold.

27. The method of claim 25, wherein the duration of the offset is specific to the communication link.

28. The method of claim 25, wherein the duration of the offset is at least as long as a duration of the propagation delay or a timing difference between the first UE and the second UE.

29. A method of wireless communication performed by a first user equipment (UE), comprising:
synchronizing a reception timing with a second UE via a communication link with the second UE; and
receiving a sidelink transmission on the communication link with an offset before or after the sidelink transmission and in accordance with the reception timing, wherein a duration of the offset is based at least in part on a propagation delay between the first UE and the second UE, a maximum supported communication range of the second UE, or a range associated with the communication link.

30. The method of claim 29, wherein the duration of the offset is at least as long as a duration of the propagation delay or a timing difference between the first UE and the second UE.
